(19) United States
(12) Patent Application Publication
(10) Pub. No.: US 2024/0123270 A1
(43) Pub. Date: Apr. 18, 2024

(54) Tank and Mobil Cergo Fire Suppression Systems

(71) Applicant: Stephen Knight, Oklahama City, OK (US)

(72) Inventor: Stephen Knight, Oklahama City, OK (US)

(21) Appl. No.: 18/445,551

(22) Filed: Oct. 10, 2023

Related U.S. Application Data
(63) Continuation of application No. 63/475,179, filed on Oct. 17, 2022.

(51) Int. Cl. A62C 35/02; A62C 3/06; A62C 3/07

(52) U.S. Cl. CPC A62C 35/023; A62C 3/065; A62C 3/07

(57) ABSTRACT

A self-activating fire suppression tank containing a pressurized nitrogen foaming agent, a heat sensor and a dispersion head is installed within a livestock or travel trailer or for stationary and mobile tanks containing combustible liquids. One or more of these fire suppression tanks offer protection which consists of at least one high mounted vessel in tack room, at least one located within a hay pod or rack mounted on roof of trailer and additional fire suppression tanks mounted in livestock stalls with remote mounted dispersion heads for deployment of fire suppression nitrogen foams where a fire is detected, with the fire sensors activated to empty the tank contents to extinguish a fire. Living quarter in these trailers are also contemplated for zone coverage and protection will also be protected where included.

### CROSS REFERENCE TO RELATED APPLICATIONS

Applicant Claims the benefit of Provisional Patent No. 63/475,179 filed on Oct. 17, 2022, by the same Inventor.

### I. BACKGROUND OF THE INVENTION

### 1. Field of Invention

A self-activating fire suppression system is provided to the inside of a stationary or mobile tank vessel or a mobile cargo compartment of a trailer. The system includes one or more compressed foaming tank filled with a suppression foam mixture, a local or remote sensor and an activator to detect a sudden rise in temperature within the tank battery or mobile cargo compartment or segregated section of the mobile cargo compartment, the sensor causing an eruption of one or more compressed foaming tanks containing a compressed nitrogen fire and smoke suppression foam mixtures to rapidly expel their contents to form a foaming layer over the surface of a combustible liquid in a tank battery or within the mobile cargo compartment of a trailer to rapidly suffocate and extinguish combustible items within the tank battery or cargo compartment, including passenger and live animals, feed, hay, or structures. The tank and component attachment may be by use of hardware, plumbing, adhesive as original or after-market installation.

### 2. Description of Prior Art

A preliminary review of prior art patents was conducted by the applicant which reveal prior art patents in a similar field or having similar use. However, the prior art inventions do not disclose the same or similar elements as the present internal tank battery fire extinguisher module, nor do they present the material components in a manner contemplated or anticipated in the prior art. None of them attach to the inside of a tank battery containing combustible liquids and vapor. None of them are self-activating, sensing a sudden rise in temperature and activating at a set temperature threshold. None of them have the ability to adhere or attach to the inner wall and none of them evacuate a safe nitrogen foaming agent which floats on the surface of the liquid to suffocate the flammable vapors, saving both the tank batteries and the contents therein. They also are not adapted to transport trailers carrying flammable substrates or livestock.

A rim rolling fire suppression module is attached to the rim of a tank and is moved around the perimeter of the tank, detects the presence and location of the fire and then moves the module to the location to expel suppression agents onto the heat source in U.S. Pat. No. 4,781,252 to Wilburn. In U.S. Pat. No. 8,955,609 to Phillips, an external vessel delivers a suppression agent through tubing and distributors to the contents of a tank after a glass, plexi-glass or plastic case is broken or melted, activating a release of the contents of the external tank into the tubing and further to one or more dispersion heads by suffocating the fire with an aqueous film forming material. In the Enk, Sr. U.S. Pat. No. 9,381,388, two separate tanks dispensing a liquid mixture released to form a semi-rigid closed cell foam within a tank, the suppression system having a detector and a pressurized propellant leading to dispersion nozzles that direct the mixture onto the surface of the contents of the tank.

In Patent Publication No. 2019/0168047 to Conboy, suppresses fires in a building, vessel or vehicle using a cloud of microscopic droplets generated from a supply of environmentally clean water and a water based free-radical chemical reacting together to cool the fire and displace oxygen. An industrial vehicle fire suppression system installs into a truck containing heavy goods with two hose reels delivering a suppression liquid comprising a toroidal-shaped tank having a water and foaming agent and a delimiting department, a pressurizing box containing a pressurization means and a mixing chamber combining nitrogen/air and the suppression water and chemical mixture to the two hose reels further applying the water, chemical nitrogen/air mixture through the hoses to extinguish a fire in the vehicle, as disclosed in U.S. Patent Publication No. 2019/0224507 to Fiorino.

### II. SUMMARY OF THE INVENTION

Two fire suppression concerns are identified in the present fire suppression technology addressed in the present system for fire suppression systems, including one or more fire foam containers, one or more local or zone fire sensors, delivery tubing and one or more foam dispersion nozzles directed to a single area or multiple independent zones, as indicated. The first is where the fire suppression system is directed to the flammable contents of a tank or vessel and the other directed to the contents of a mobile trailer carrying cargo or livestock.

Historically, tank batteries have been known to ignite due to accidents and natural lightning strikes, resulting in the entire contents being burned and the tank batteries destroyed. The value of the contents and lost tank batteries due to loss is substantial. The ignition is sudden, the tank batteries are usually miles away from any responders, and the loss is generally total to both the content and the equipment. There is also an issue with containment, when one tank battery explodes and ignites other tank batteries as well as the property surrounding the fire incident. Unless someone is in the immediate proximity and capable of immediate extinguishment of the fire, these losses are virtually unpreventable, and at great risk to the person attempting to quell the fire. The self-activating local and internal tank fire suppression system requires no human intervention or activation, completely eliminates the fire and prevents reignition, and can be recharged after the tank and contents are recovered and preserved, as well as eliminating threat of fire spread to the adjacent structures.

The second occurrence deals with mobile trailers that are usually ignited by careless smokers who dispose of cigarettes while traveling, or caused by sparks from metal chains or other vehicle failed components creating sparks during travel and also by semi-tractor trailers that are running on flat tires or wheels without knowledge of the driver. Many livestock trailers and other travel trailers contain flammable components and objects, including paper, cardboard, wooden pallets and flammable structures, feed hay, bedding straw, baled hay, dry feed and most often valuable livestock which is not necessarily combustible but tragically lost or mortally injured during livestock trailer fires. Many times, the driver towing the trailer is not aware of the fact that the trailer is on fire until after having traveled several miles, during which time the fire is fanned beyond recovery and loss of life and contents.

The present fire suppression module needs no human supervision, activation or monitoring and is present and active 24 hours per day, seven days a week. It removeably attaches to the inside of the tank battery or trailer, either by magnetic force or an adhesive, hardware or plumbing in one or more pre-determined locations and activate in one or more zones. It contains a sufficient amount of compressed nitrogen foaming agent canisters in relation to the content volume of the tank vessel or square footage and layout of the trailer or vessel, and provides an immediate response to a sudden temperature increase, which activates the local or remote heat sensor and opens a one or more relevant check valves to direct the pressurized nitrogen foaming agents and nitrogen gasses to spread a layer of suffocating active foam over the surface of the liquid or flammable contents to eliminate vaporized liquid content and preclude any oxygen from the air above the liquid or flammable content to immediately eliminate fire within the tank vessel or extinguish the inflamed contents of the trailer.

Once extinguished, the liquids will not reignite due to lack of access to oxygen within the tank vessel and wet foam covering the trailer contents, including the animals for the period of time it takes to clean and treat the animals after recovery. Once extinguished, the tank vessel can be cleaned and restored to function without loss to the tank vessel, tank batteries, or combustible liquid content and a new fire suppression system installed. A trailer may also be evacuated and cleaned and restored with less loss to contents and structure. After recovery, the fire suppression model can be replaced or restored by reconditioning the module components with negligible interruption of the tank battery operations or loss of use of the trailer, most likely accomplished during the repair of the tank or trailer.

### III. DESCRIPTION OF THE DRAWINGS

The following drawings are submitted with this utility patent application.

FIG. 1 is a perspective view of a fire suppression system with a single tank embodiment and a magnetic surface attaching means.

FIG. 2 is a multiple tank embodiment of the fire suppression system in a multiple tank embodiment with a magnetic surface connecting means.

FIG. 3 is a diagram of the fire suppression system in a tank vessel on fire at the time of activation as the suppression foam is dispersed.

FIG. 4 is a diagram of the fire suppression system in a tank vessel after the fire has been suppressed with the suppression foam covering the surface of the liquid within the tank vessel.

FIG. 5 is an upper view of a layout of the inside of a stock trailer with multiple fire suppression modules throughout the inside of the trailer covering multiple zones.

FIG. 6 is a side cutaway view of a stock trailer showing multiple fire suppression modules throughout the inside of the trailer covering multiple zones.

FIG. 7 is an upper view of a different embodiment of the inside of a stock trailer with multiple fire suppression modules with tubing and remote spray heads and sensors at terminal ends.

FIG. 8 is a bottom view of the stock trailer showing a pair of fire suppression modules with deliver tubing and terminal ends with remote spray heads directed towards the wheels tires and wheel bearing of the stock trailer.

### IV. DESCRIPTION OF THE PREFERRED EMBODIMENT

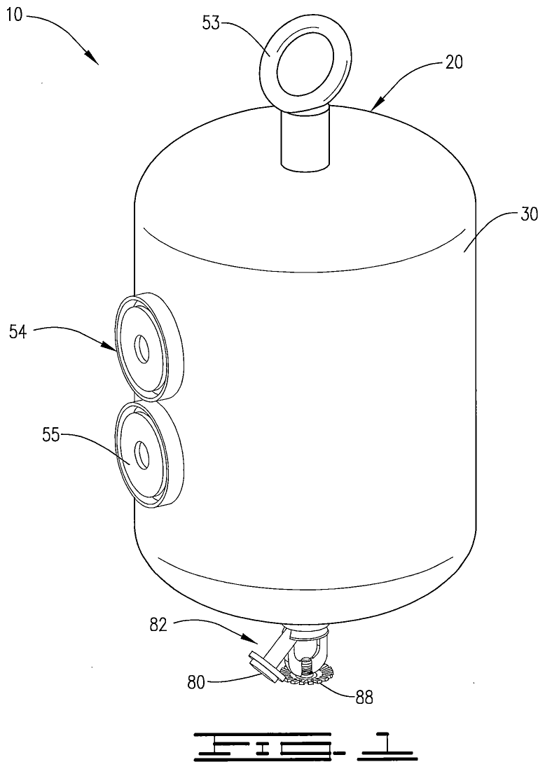

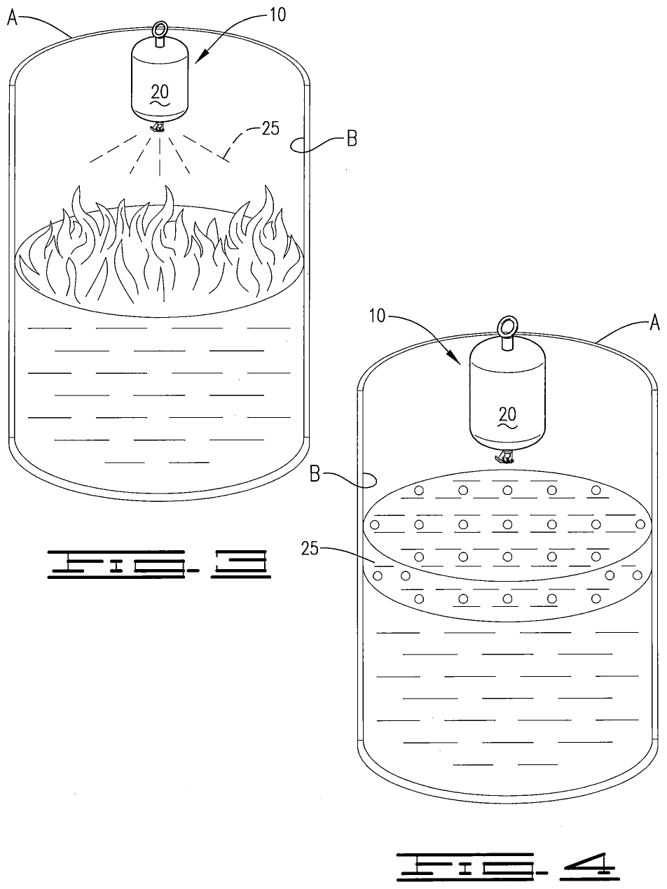

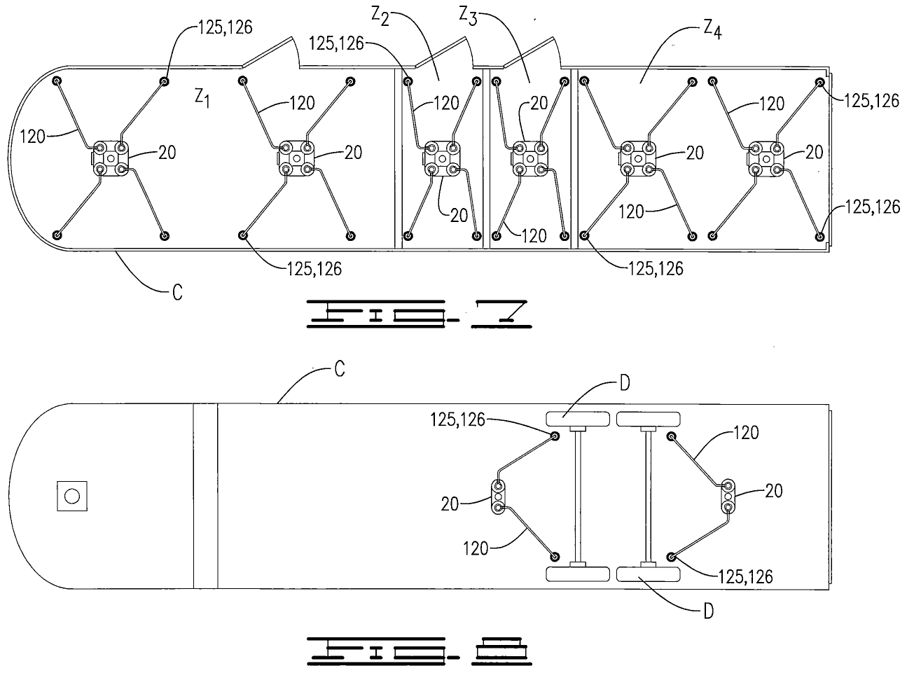

A self-contained and locally activated fire suppression system 10 provides an immediate response to a fire within a storage tank vessel A containing a flammable liquid and vapor and any mobile trailer C used for transporting livestock, animals, cargo or recreation, as indicated in FIGS. 1-8 of the drawings. Absent constant observations, it is known that these trailers and vessels can ignite and be irretrievably lost, including contents, before human intervention is available. Therefore, an immediate and automatic fire suppression response is provided in the present fire suppression system 10.

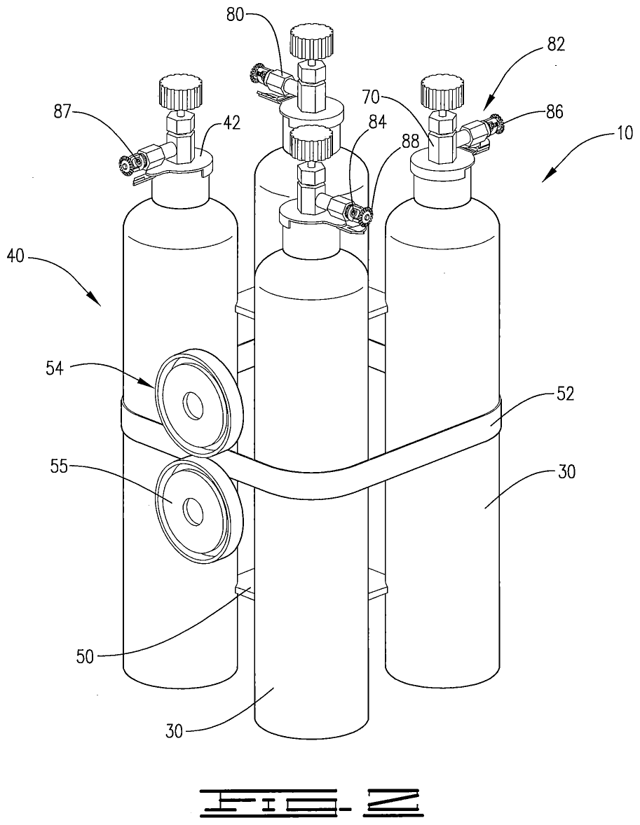

In a first embodiment, a tank battery fire suppression module 20 is a self-contained and self-activating fire suppression system 10 which is placed inside a tank vessel A containing a combustible liquid and vapor product, FIGS. 1-4. The fire suppression module 20 may be used in a tank vessel A made of metal, composite or other and is attached to an inner wall B or surface of the tank vessel A by magnetic or adhesive means. This first embodiment comprises one or more pressurized foaming agent vessels 30 or cartridge bundle 40, each cartridge bundle or vessel 40, 30 containing a pressurized suppression foam 25 combining a mixture of a surfactant and nitrogen gas or one or more cartridges 30 containing a pressurized surfactant and one or more cartridges containing pressurized nitrogen gas, FIG. 2. Each cartridge or vessel 30 is connected by way of a cartridge cap 42 through a respective check valve 80 to an optional mixing chamber 70 which is directed to one or more discharge outlets 82, either directly or through extended delivery tubing 120. Deliver is also contemplated directly from the check valve 80 to the discharge outlet in the pre-mixed battles or vessels. 30, 40. A local or remote heat sensor 84 is placed below the discharge outlet 82 which senses the heat inside the relative vessel and upon reaching the set relevant temperature limit of the heat sensor, opens the check valve 80 to release a flow of the contents of the cartridge bundle 40 or vessel 30, spraying a blanket of suppression foam and nitrogen 25 over the surface of the fire and/or combustible liquid and vapor content, suffocating the fire and by compiling a foam and nitrogen layer over the surface of the combustible liquid and vapor content to remove any oxygen content overlying the combustible liquid and vapor. Optimally, the expulsion of the cartridge bundle 40 or vessel 30 contents is accomplished in under a minute. The cartridge bundle 40 volumes should be supplied relative to the content volume of the tank vessel A.

More specifically, each foam cartridge of the cartridge bundle 40 is a commercially available pre-mixed bottle purchase in varying quantities of compressed bottled nitrogen foaming mixtures with an bottle cap 42 defining a cap ridge and an upper release membrane, not shown with a commercially common penetrating needle and cap seal. In addition, some embodiments may be presented as compressed nitrogen gas only to provide more suffocating air content of nitrogen to displace or saturate the oxygen in the tank where the combustible vapor lie above the liquid flammable or combustible materials may provide upper flammable vapors.

A support frame 50 for the multiple cartridge bundle 40 fire suppression module 20 are held together into a single modular unit assembly, shown in FIG. 2 with an adjustable band 52. A support frame 50 attaches to an inner wall B or surface within the inner tank battery by a wall connecting means 54. In the case where attachment is to a conductive metal tank vessel, as indicated in FIG. 2, the wall connecting means 54 can be at least one strong magnet 55. In other embodiment, the frame may attach to a non-conductive metal wall by an epoxy, or by a conductive metal plate or base member 53 mounted to the non-conducting tank vessel wall by an epoxy, not shown, further attaching the fire suppression module by the same magnet 55 as indicated in the single and multiple tank modules, FIGS. 1-2. The purpose of a temporary wall connecting means 54, base member 53 or magnet 55 is to replace a spent fire suppression module once a first fire suppression module has been expended, possibly within the same tank vessel that was previously preserved and salvaged.

The adjustable band 52 secures each respective cartridge bundle 40 together prior to placement within the vessel, or a single vessel 30 is used, either presentation being an option. The cartridges or vessel provides communication with the contents of each respective cylinder to release the suppression foam 25 through a respective check valve 80 within a respective delivery tubing 120 to a terminal end 125 or spray head 126, or alternatively to a local discharge/dispersal outlet 82, via a heat sensor 84, exit valve 86, nozzle 87 and expander 88 connected directly to the cartridge bundle 40 or vessel 30. In the cartridge bundle, an individual mixing chamber 70, can be provided to receive the contents of each cartridge contemporaneously if more than one tank vessel is connected. The mixing chamber 70 extends the respective local heat sensor 84 and exit valve 86 directing the nitrogen containing foams outward under pressure to a nozzle 87 and an expander 88, FIGS. 1-4.

The local heat sensor 84 is supplied with a liquid content that, when exposed to a predetermined heat level, creates in internal pressure upon the liquid content (mercury or alcohol as used in a common thermometer), ruptures a section of glass tubing surrounding the liquid content, opening a pathway to the discharge outlet 82 spraying the blanket of foaming agent and nitrogen over the fire or surface of the combustible liquid and vapor content, suffocating the detected fire and filling the area over the surface of the combustible liquid and vapor content with nitrogen to remove an oxygen content overlying the combustible liquid and vapor over the combustible liquid and vapor. Optimally, the expulsion of the cartridge bundle 40 or vessel 30 contents is accomplished in under a minute. The cartridge volumes should be supplied relative to the content volume of the tank vessel A by either the number of cartridges 40 combined within each fire suppression module 20 or by volume of the selected single tank used in the fire suppression module 20 relative to the volume of the tank vessel A being monitored and protected.

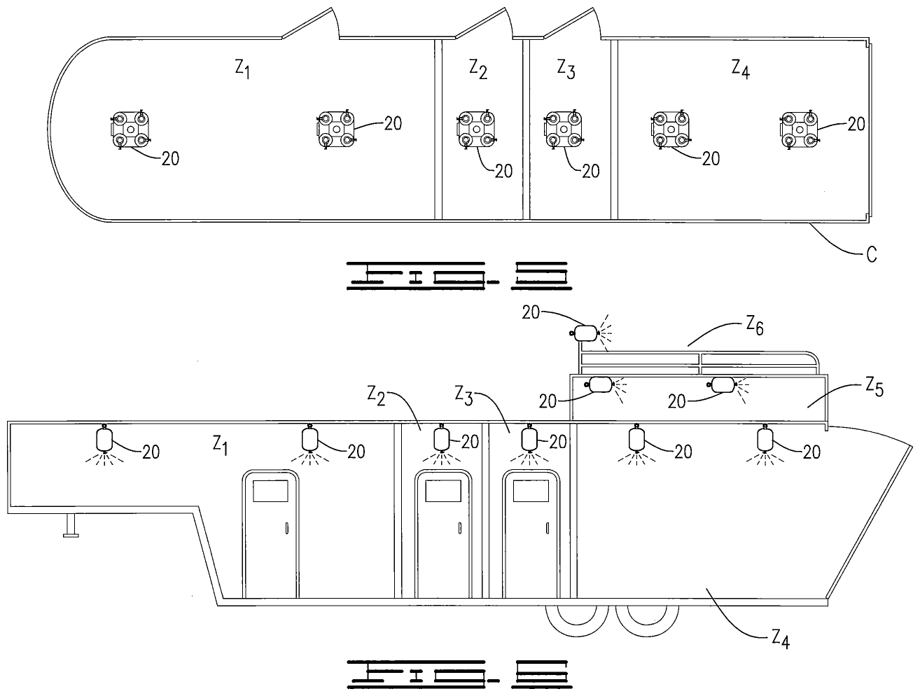

In a second embodiment adapted to the fire suppression system 10 for use in a mobile trailer C, the suppression system 20 defines one or more self-contained and locally activated fire suppression modules 20 installed in one or more areas of the trailer interior and exterior, FIGS. 5-8, independently and automatically activated and dispensing the suppression foam in one or more areas where fire is present. Each fire suppression system is designed to protect a particular “zone” Z₁₋₆ within the trailer C. In these systems, each “zone” Zₓ includes one or more tank vessels 30 or pressurized foam cartridge bundles 40, connecting delivery tubing 120 to and leading from the tank vessel 30 or foam cartridge bundles 40 to one or more terminal ends 125, each terminal end comprising a check valve 80, the heat sensor 84, a dispersal outlet 82 forming a nozzle 87 and a dispersal expander 88 to increase the pressurized suppression foam coverage.

In this embodiment, the heat sensor 84 is remote and activated by a preset and self-contained activation module, not shown, which may be wired or wirelessly in communication with the check valve 80 to open the check valve 80 and release the suppression foam 25 and nitrogen gas to one or more spray heads 126 located at a terminal end 125 of delivery tubing 120 to a particular zone Z₁₋₆. The objective is to dispense as much foam as possible to the largest area in the shortest amount of time, as time and volume are of the essence in fire suppression. It is also the objective of the foam suppression system 10 to eliminate any and all fire sources before they become irreversibly out of control. The fire suppression system 10 design and coverage should be subjectively designed and installed for each trailer, as indicated in two embodiments shown in FIGS. 5-7. After a fire suppression event, the fire suppression system 10 components that have been used may be replaced or recharged as needed and during the time it takes to repair the damaged components in the mobile trailer. When used in the mobile trailers C that transport livestock or animals, greater care would be used in choosing the chemical components of the fire suppression foam to ensure that the fire suppression foam bears minimal or no harm to the livestock and animals being transported therein.

In this second embodiment, it is best indicated that at least partial overlapping of zones Z₁₋₆ are recommended to ensure there are no zones insufficiently treated and over suppression is better than too little application. It is also recommended that a preference for single tank use over multiple tank bundles 30 as fire suppression modules would be considered in the engineering and anticipated coverage aspects of the fire suppression system design. Modification to the components used in the present first and second embodiments of the tank and trailer fire suppression systems and modifications thereto arecontemplated within the scope of this patent application, including plumbing hardware, installation hardware, heat sensors and system activation components, foaming agents and surfactants, tank volume and pressure rechargeability and active status indication. It is also contemplated that a manual activation override can be incorporated into the fire suppression system for both the first and second embodiments, not shown.

In addition to the inner portions of the trailer C, it is common for fires to originate and occur underneath the trailers, especially in the vicinity of the trailer wheels and tires D, FIG. 8. Trailers often have flat tires during transport, which can originate a fire, especially on dual axels, where one tire remains intact while the other runs flat. This can go undetected for miles, thus making the automatic and self-activating fire suppression system 10 for trailers C most unique and useful. Wheel bearing failure also can result in a locked wheel, which also causes friction or sparking. Thus, the application of the fire suppression system to the wheel and tire D areas under the trailer C is also illustrated in FIG. 8, representing one or more fire suppression modules directed by tubing to each wheel D on each side of the trailer C. It may also be useful for some type of remote alert system to be employed within a vehicle used to tow the trailer C to alert the operator that the fire suppression system has been activated and the fire suppression system deployed so that they may pull off the road to avoid further damage and harm to other traffic on the roadway.

While the fire suppression systems 10 have been particularly shown and described with reference to a preferred embodiment thereof, it will be understood by those skilled in the art that changes in form and detail may be made therein without departing from the spirit and scope of the invention. Many modifications to the delivery systems for the fire suppression foam 25 are contemplated, both local and remote and applied to single vessel 30 and cartridge bundle 40 systems as disclosed and as contemplated within the scope of this specification, drawings and claims.

What is claimed is:

1. A self-activating and self-contained fire suppression system for installation within a liquid storage tank containing a combustible liquid, comprising:
one or more tank vessels attached to an inner wall of said storage tank vessel above said combustible liquid by a wall connecting means above said combustible liquid, each said one or more tank vessels containing a pressurized suppression foam and nitrogen gas;
a check valve which contains said pressurized suppression foam and nitrogen gas within each said one or more tank vessels;
a local or remote heat sensor which senses the presence of a fire or combustion heat at a preset temperature, resulting in a release of each said check valve;
a discharge outlet directing said suppression foam from each said check valve to a respective exit valve and a nozzle; and
an expander which spreads said suppression foam and nitrogen gas to a surface of said combustible liquid within said storage tank to suffocate said fire and suspend said nitrogen gas over said combustible liquid and deployed suppression foam to prevent reignition of said combustible liquid.

2. The self-activating and self-contained fire suppression system of claim 1, further comprising:
said one or more tank vessel is a single tank vessel;
said wall connecting means is a strong magnet where said liquid storage tank is metal; and
said single tank vessel has the capacity to be recharged, reuse and refurbished after a fire suppression incident by replacing said local or remote heat sensor, replacing or resetting said check valve, and replacing any other element which was damaged or destroyed in said previous fire suppression incident.

3. The self-activating and self-contained fire suppression system of claim 1, further comprising:
said one or more tank vessel is a cartridge bundle held together by at least one adjustable band and lead to a common mixing chamber upon release of said check valve and forward to said discharge outlet;
said wall connecting means is a strong magnet where said liquid storage tank is metal or an epoxy attached to a non-metallic tank; and
said cartridge bundle is replaced after a fire suppression incident, said local or remote heat sensor is replaced, said check valves for each said cartridge bundle is replaced, and any other element which was damaged or destroyed in said previous fire suppression incident.

4. A self-activating and self-contained fire suppression system for installation within and upon a mobile trailer, comprising:
a plurality of one or more tank vessels forming an individual fire suppression module attached within and upon said mobile trailer by a wall connecting means, each said fire suppression module respectively directed an specific individual zone within and upon said mobile trailer, each said one or more tank vessels containing a respective quantity of pressurized suppression foam and nitrogen gas;
a check valve which contains said pressurized suppression foam and nitrogen gas within each said one or more tank vessels;
a respective local or remote heat sensor which senses the presence of a fire or combustion heat at a preset temperature assigned to each respective check valve within each said fire suppression module, resulting in a release of each said check valve for said respective fire suppression module;
a respective discharge outlet directing said suppression foam from each said check valve to a respective exit valve and a nozzle; and
an expander which spreads said suppression foam and nitrogen gas to said respective specific individual zone, coating said zone with said suppression foam to extinguish any said fire within said specific individual zone.

5. The self-activating and self-contained fire suppression system of claim 4, further comprising:
each said fire suppression module attaches common delivery tubing to each said one or more tank vessels, leading to one or more terminal ends defining a spray head directing said suppression foam from each said fire suppression module activated by said respective local or remote heat sensor to multiple areas within each said, specific individual zone assigned to each said respective fire suppression module.

6. The self-activating and self-contained fire suppression system of claim 4, further comprising:
said specific individual zones within said mobile trailer may include living quarters, livestock quarters, feed storage and tack rooms, cargo storage areas, rooftop hay storage compartments or platforms, and under trailer wheels, tires and wheel wells, each zone having assigned one or more segregated yet overlapping fire suppression modules, one or more tank vessels, one or more local or remote heat sensors, segregated deliver tubing, and one or more terminal ends and spray heads, each said fire suppression module, delivery tubing and terminal end being applied as original or after-market installation equipment implementing the perceived engineering concerns of each subjective mobile trailer, its functions and uses.

7. The self-activating and self-contained fire suppression system of claim 4, further comprising any other element as disclosed in the specification, drawings and claims.
